(19) United States
(12) Patent Application Publication
(10) Pub. No.: US 2006/0143365 A1
(43) Pub. Date: Jun. 29, 2006

(54) Memory device, memory managing method and program

(75) Inventor: Syuichi Kikuchi, Sendai, Miyagi (JP)

Correspondence Address: Mitchell P Brook;Luce Forward Hamilton & Scripps, 11988 El Camino Real, Suite 200, San Diego, CA, 92130, US

(73) Assignee: Tokyo Electron Device Limited, Kanagawa (JP)

(21) Appl. No.: 10/518,417

(22) PCT Filed: Jun. 17, 2003
(86) PCT No.: PCT/JP03/07672

§ 371 Date: Dec. 17, 2004

(30) Foreign Application Priority Data
Jun. 19, 2002 (JP) 2002-178674

(51) Int. Cl. G06F 12/00; G06F 12/10

(52) U.S. Cl. 711/103; 711/202

(57) ABSTRACT

Disclosed is a memory device which is not easily deteriorated and a memory managing method which does not easily deteriorate a memory device. A physical address is given to a memory area of a flash memory (11) page by page. When supplied with to-bewritten data and a logical address where the data is to be written, a CPU (121) writes this data in a page indicated by a write pointer. The correlation between the physical address and the logical address of the page is stored in a RAM (123) in the form of BPT (Block Pointer Table). At the time of reading, the CPU (121) that has been supplied with the logical address searches the BPT to specify a physical address associated with that logical address and reads data from that page which is given the specified physical address. Flash erasing of a block is executed when the number of empty blocks becomes equal to or smaller than a predetermined number.

### TECHNICAL FIELD

The present invention relates to a memory device, a memory managing method and a program, and, more particularly, to a block erasure type memory device, and a memory managing method and a program which manage a block erasure type memory device.

### BACKGROUND ART

An EEPROM (Electrically Erasable/Programmable Read Only Memory) flash memory is used as a recording medium which is accessible (data readable and erasable) by a computer or the like.

A flash memory performs data erasure in the units of a predetermined memory capacity (which are generally called “blocks”).

Of flash memories, particularly, a NAND type has a difficulty in sufficiently preventing the occurrence of defective blocks, which cannot carry out the proper data storage at the manufacturing stage. To cope with the difficulty conventionally, consecutive logical addresses separate from physical addresses allocated to the respective blocks are dynamically allocated to proper blocks and an address translation table which shows the correlation between the physical addresses and the logical addresses is prepared to avoid complication of external access procedures which may be originated from addresses becoming discontiguous.

The allocation of physical addresses is carried out block by block and a page is specified from a logical address by using a page address, which indicates the order of pages in a block in addition to the physical address associated with the logical address. (Provided that data is stored in sectors in order from the top sector within the same block, data which is supplied contiguously (e.g., data constituting one file) is stored in contiguous pages in the same block.) At the time of rewriting data, therefore, consideration should be taken so as to maintain the order of that page in the block where data to be rewritten is to be stored.

Specifically, data which is not to be rewritten is transferred to an empty block at the transfer destination from the sender block where to-be-rewritten data is to be stored, in such a way that the order of data is kept. That is, with n being the order of a page, data that has been in the n-th page in the sender block is transferred to the n-th page at the transfer destination. Data to be rewritten is rewritten in such a way that rewritten data keeps the order of data before rewriting. That is, with m being the order of a page, data that has been written over data that has been in the m-th page in the sender block is transferred to the m-th page at the transfer destination. Then comes the execution of an operation of flash-erasing the sender block (or erasing the memory content).

In case of rewriting a file whose amount of data is very small as compared with the memory capacity for one block, however, execution of such an operation flash-erases a block that includes lots of pages which store data irrelevant to the file and pages which are not holding data.

While a NAND type flash memory can achieve a large-capacity structure at a low cost, it would be too degraded to perform proper data reading and writing by repetitive flash erase. That is, executing the aforementioned operation rewrites a small amount of data, which results in inefficient frequent flash erase. This quickens the degrading of the flash memory.

In case where an OS (Operating System) manages the memory contents of a flash memory by a scheme similar to the one that manages the memory contents of a hard disk unit or a flexible disk, particularly, a FAT (File Allocation Table) or the like, which shows the correlation between the individual pieces of data managed by the OS and the logical addresses where those data are stored is written in the flash memory, and is frequently updated. The amount of data in the FAT is normally very smaller than the memory capacity for one block, rewriting the FAT causes inefficient flash erase to be frequently carried out.

### DISCLOSURE OF INVENTION

The invention has been made in consideration of the above-described situations and aims at providing a memory device, which is not easily degraded, and a memory managing method, which does not easily deteriorate a memory device.

To achieve the object, a memory device according to the first aspect of the invention is characterized by comprising:

a memory (11) including a plurality of memory blocks for storing data to which physical addresses are allocated;

a translation table memory (123) which stores an address translation table showing a correlation between physical addresses of pages constituting each of the memory blocks and logical addresses of the pages;

a pointer memory (123) which specifies an empty page in a data storable state from among the pages and stores a write pointer indicating a physical address of the specified empty page; and

a controller (12, S311, S314) which, when to-be-written data and a logical address are supplied to the memory device, writes the to-be-written data in the empty page indicated by the write pointer, and renews the address translation table in such a way as to show a correlation between the physical address of that empty page and the logical address.

As this memory device performs data writing page by page, it eliminates the need for an operation of searching for a new empty block (a block that is not holding data) and writing data every time data is written. Even in case where erasure of old data accompanies data writing (specifically, the case where data is rewritten), inefficient flash erase of memory blocks can be avoided, making it difficult to cause degrading of the memory device.

Data writing which is followed by erasure of old data should be achieved by, for example, allowing the controller (12) to:

designate memory blocks from which data is to be erased from among those memory blocks which have data stored therein (S501), and

discriminate whether data stored in the designated memory blocks is valid or not, for each of those pages which constitute the designated memory blocks, transfer that data which has been discriminated as valid to another memory blocks (S502, S506), and erase that data which is stored in the designated memory blocks (S503).

The controller (12) may be allowed to discriminate whether or not the number of those memory blocks which do not have data stored therein becomes a number which does not satisfy a predetermined condition (S317), in which case memory blocks may be designated from which data is to be erased from among data-storing memory blocks when having discriminated that the number of the memory blocks which do not have data stored therein has become the number which does not satisfy the predetermined condition (S501). In this case, data erasure does not take place while there are a sufficient number of empty blocks, so that wasteful flash erase can be avoided.

The controller (12) may write an invalid flag indicating that data stored in a page to which a logical address has been allocated at a time to-be-written data and the logical address may be supplied to the memory device is invalid in that page once (S310), and

the controller (12) may designate an oldest-data storing memory block among those data-storing memory blocks that include pages where the invalid flag is written once, as a memory block from which data is to be erased (S501). In this case, the frequency of flash erase of individual memory blocks becomes even. This can prevent the concentrated deterioration of a specific memory block, which would otherwise shorten the life of the entire memory device. The controller (S502, S506) may eliminate, for example, data stored in that page where the invalid flag is written once from those targets which are to be transferred to the another memory block.

A physical address may include block addresses indicating that block to which a page indicated by the physical address belongs, and block address may be cyclically ordered.

In this case, if the controller (S501) is allowed to designate, as a memory block from which data is to be erased, that one of data-storing memory blocks which is or follows a last block where data has been erased and to which a top block address is given, the memory blocks are flash-erased in the order of the block addresses, thereby making the frequency of flash erase of individual memory blocks even.

The controller (12) may write an invalid flag indicating that data stored in a page to which a logical address has been allocated at a time to-be-written data and the logical address are supplied to the memory device is invalid in that page once (S310). In this case, invalid data is erased from the memory area at the time a memory block is flash-erased if data stored in that page where the invalid flag is written once is eliminated from those targets which are to be transferred to the another memory block (S502, S506).

The controller (12) may write a logical address supplied to the memory device in that page where the to-be-written data has been written (S314). In this case, invalid data is erased from the memory area at the time a memory block is flash-erased if it is discriminated whether or not the logical address stored in the page coincides with that logical address which is associated with the physical address of that page in the address translation table, and data stored in that page is eliminated from those targets which are to be transferred to the another memory block when having discriminated that there is no coincidence (S501, S502, S506).

Physical addresses may be cyclically ordered. In this case, if the pointer memory (123) specifies a top one of those empty pages which are given physical addresses equal to or following the physical address of that page where data is written, data writing is carried out in the orders of physical addresses, so that concentrated writing into a specific memory block can be avoid. This can prevent the execution of flash erase from being concentrated onto the writing-concentrated memory block.

When the logical address of a to-be-read page is supplied to the memory device, for example, the memory device may specify a physical address associated with the logical address based on the address translation table and data is read out from that page which is indicated by the specified physical address and is sent outside (S206 to S214).

When the logical address of a to-be-read page is supplied to the memory device, for example, the memory device may specify that page which is given the logical address based on the address translation table and data is read out from the specified page and is sent outside (S206 to S214).

If the address translation table shows a correlation between predetermined upper digits of the physical address of each page and the logical address of that page, the amount of information on the physical address can be small so that the memory area for storing the address translation table can be saved, thus making the entire memory device compact.

In this case, the controller (12) may write a logical address supplied to the memory device in, for example, that page where the to-be-written data has been written, and when the logical address of a to-be-read page is supplied to the memory device, for example, a value of the predetermined upper digits of the physical address associated with the logical address should be specified based on the address translation table and data should be read out from that page which is included in individual pages each having a physical address whose upper digits coincide with the specified value and in which the logical address of the to-be-read page is written, and should be sent outside (S206 to S214).

The controller (12) may write an invalid flag indicating that data stored in a page to which a logical address has been allocated at a time to-be-written data and the logical address are supplied to the memory device is invalid in that page once (S310).

In this case, data should be read out from that page which is included in individual pages each having a physical address whose upper digits coincide with the specified value and in which the logical address of the to-be-read page is written and the invalid flag is not written, and should be sent outside (S206 to S214).

The physical addresses may be cyclically ordered.

In this case, the pointer memory (123) may specify a top one of those empty pages which are given physical addresses equal to or following the physical address of that page where data is written, and

the controller (12) may read out data from a lowest-ordered page in those individual pages each having a physical address whose upper digits coincide with the specified value and in which the logical address of the to-be-read page is written, and may send the data outside (S206 to S214).

Even in case where the address translation table shows a correlation between predetermined lower digits of the physical address of each page and the logical address of that page, and a range over which a value of a physical address can be associated with a logical address is determined for each logical address, the amount of information on the physical address can be small so that the memory area for storing the address translation table can be saved, thus making the entire memory device compact.

In this case, when the logical address of a to-be-read page is supplied to the memory device, for example, the controller (S206 to S214) should specify a value of the predetermined lower digits of the physical address associated with the logical address is specified based on the address translation table, and read out data from that page which is included in individual pages each having a physical address whose lower digits coincide with the specified value and which is given a physical address lying in the range, and send that data outside.

The translation table memory (123) may be constituted by a non-volatile memory, which stores the address translation table. With such a structure, the memory device does not need to store the address translation table again every time the device is activated.

The translation table memory (123) may be constituted by the page that stores the address translation table. With such a structure, the memory device does not need to store the address translation table again every time the device is activated.

In this case, for example, the controller (S310 to S312) should read at least a part of the address translation table from the page, renews the read part in such a way as to show a correlation between the physical address of the empty page indicated by the write pointer and the logical address and write the renewed part in another empty page (S601 to S603).

The controller (12) may store an address translation table storage location list showing physical addresses of those pages, which store data constituting the address translation table (S105B).

In this case, for example, the controller (12) should refer to the address translation table by reading at least a part of the address translation table from that page which is given a physical address indicated by the address translation table storage location list, renewing the read part in such a way as to show a correlation between the physical address of the empty page indicated by the write pointer and the logical address, writing the renewed part in another empty page, and renewing the address translation table storage location list in such a way as to show the physical address of the another empty page (S602, S603).

Provided that a range of a value of upper digits of the physical address of each of those pages which store data constituting the address translation table is predetermined, the amount of information on the address translation table storage location list can be small so that the memory area for storing the address translation table storage location list can be saved, thus making the entire memory device compact.

In this case, for example, the controller (12) should refer to the address translation table by storing an address translation table storage location list showing predetermined lower digits of the physical address of each of those pages which store data constituting the address translation table (S105B), reading at least a part of the address translation table from that page which is included in pages each having a physical address whose predetermined lower digits are specified by the address translation table storage location list and the predetermined upper digits of the physical address of which lies in the range, renewing the read part in such a way as to show a correlation between the physical address of the empty page indicated by the write pointer and the logical address, writing the renewed part in another empty page, and renewing the address translation table storage location list in such a way as to show the physical address of the another empty page (S602, S603).

The controller (S601 to S603) may specify that page which stores a part showing a correlation between the logical address supplied to the memory device and the physical address from among those pages which have the address translation table stored therein, read only that part which is stored in the specified page, renew the read part in such a way as to show a correlation between the physical address of the empty page indicated by the write pointer and the logical address and write the renewed part in another empty page.

Because such a structure does not require the operation of reading the entire address translation table every time the address translation table should be referred to, the time needed to access the address translation table is shortened.

The memory device may further comprise a non-volatile memory (123) which stores an empty block table containing information for identifying that memory block which does not have data stored therein. With such a structure, the memory device does not need to store the address translation table again every time the device is activated.

In this case, for example, in that the controller (12) should discriminate whether or not writing to-be-written data supplied to the memory device in an empty page has resulted in that the memory block which includes the empty page has no further empty page, and renew the empty block table in such a way as to indicate that the memory block including the empty block has the data stored therein, when having discriminated that the memory block including the empty block has no further empty page (S315, S316), and

should renew the empty block table in such a way as to indicate that a memory block from which data to be stored has been erased does not have that data stored therein.

Some of the pages may constitute empty block table memory means (11) which stores an empty block table containing information for identifying that memory block which does not have data stored therein. With such a structure too, the memory device does not need to store the address translation table again every time the device is activated.

In this case, for example, the controller (12) should refer to the empty block table by discriminating whether or not writing to-be-written data supplied to the memory device in an empty page has resulted in that the memory block which includes the empty page has no further empty page, and, when having discriminated that there is no further empty page, reading at least a part of the empty block table from the empty block table means, renewing the empty block table in such a way as to indicate that the memory block including the empty block has the data stored therein, storing the renewed empty block table in the empty block table means (S315, S316), reading at least a part of the empty block table from the empty block table means, renewing the empty block table in such a way as to indicate that a memory block from which data to be stored has been erased does not have the data stored therein, and storing the renewed empty block table in the empty block table means (S504).

The controller (12) may store an empty block table pointer indicating the physical address of a page storing that data which constitutes the empty block table (S107).

In this case, for example, the controller (12) should refer to the empty block table by reading at least a part of the empty block table from that page which is given the physical address indicated by the empty block table pointer.

If a range of a value of upper digits of the physical address of each of those pages which store data constituting the address translation table is predetermined, the amount of information on the empty block table pointer can be small so that the memory area for storing the empty block table pointer can be saved, thus making the entire memory device compact.

In this case, for example, the controller (12) should refer to the empty block table by storing an empty block table pointer indicating predetermined lower digits of the physical address of a page storing that data which constitutes the empty block table (S107), and reading at least a part of the empty block table from that page which is included in pages each having a physical address whose lower digits are specified by the empty block table pointer and which has a physical address whose upper digits lie in the range (S308).

The controller (12) may specify that page in which a to-be-renewed part in the stored empty block table is stored from among those pages which have the empty block table stored therein, and read out only that part which is stored in the specified page.

Because such a structure does not require the operation of reading the entire empty block table every time the empty block table should be referred to, the time needed to access the empty block table is made shorter.

According to the second aspect of the invention, there is provided a memory managing method for managing a plurality of memory blocks for storing data to which physical addresses are allocated, characterized in that

an address translation table showing a correlation between physical addresses of pages constituting each of the memory blocks and logical addresses of the pages is stored (S105),

an empty page in a data storable state is specified from among the pages and a write pointer indicating a physical address of the specified empty page is stored (S107), and

when to-be-written data and a logical address are supplied, the to-be-written data is written in the empty page indicated by the write pointer, and the address translation table is renewed in such a way as to show a correlation between the physical address of that empty page and the logical address (S311, S314).

As this memory managing method carries out data writing page by page, it eliminates the need for an operation of searching for a new empty block (a block, which is not holding data,) and writing data every time data is written. Even in case where erasure of old data accompanies data writing (specifically, the case where data is rewritten), inefficient flash erase 6f memory blocks can be avoided, making it harder to cause degrading of the device that has memory blocks.

Data writing which is followed by erasure of old data should be achieved by designating memory blocks from which data is to be erased from among those memory blocks which have data stored therein (S501), and

discriminating whether data stored in the designated memory blocks is valid or not, for each of those pages which constitute the designated memory blocks, transferring that data which has been discriminated as valid to another memory blocks, and erasing that data which is stored in the designated memory blocks (S502, S506, S503).

Provided that it is discriminated whether or not the number of those memory blocks which do not have data stored therein becomes a number which does not satisfy a predetermined condition (S317), and when it is discriminated that the number of the memory blocks which do not have data stored therein has become the number which does not satisfy the predetermined condition, a memory block from which data is to be erased is designated from among data-storing memory blocks (S501), data erasure does not take place while there are a sufficient number of empty blocks, so that wasteful flash erase can be avoided.

According to the third aspect of the invention, there is provided a program for allowing a computer (121), connected to a memory (11) including a plurality of memory blocks for storing data to which physical addresses are allocated, to function to:

store an address translation table showing a correlation between physical addresses of pages constituting each of the memory blocks and logical addresses of the pages (S105);

specify an empty page in a data storable state from among the pages and store a write pointer indicating a physical address of the specified empty page (S107); and

when to-be-written data and a logical address are supplied to the computer, write the to-be-written data in the empty page indicated by the write pointer and renew the address translation table in such a way as to show a correlation between the physical address of that empty page and the logical address (S311, S314).

As the computer, which executes such a program, carries out data writing page by page, it eliminates the need for an operation of searching for a new empty block (a block which is not holding data) and writing data every time data is written. Even in case where erasure of old data accompanies data writing (specifically, the case where data is rewritten), inefficient flash erase of memory blocks can be avoided, making it difficult to cause degrading of the memory device.

The program should achieve data writing which is followed by erasure of old data by, for example, allowing the controller (12) to:

designates memory blocks from which data is to be erased from among those memory blocks which have data stored therein (S501), and

discriminates whether data stored in the designated memory blocks is valid or not, for each of those pages which constitute the designated memory blocks, transfers that data which has been discriminated as valid to another memory blocks, and erases that data which is stored in the designated memory blocks (S502, S506, S503).

Provided that the program discriminates whether or not the number of those memory blocks which do not have data stored therein becomes a number which does not satisfy a predetermined condition (S317), and designates memory blocks from which data is to be erased from among data-storing memory blocks when having discriminated that the number of the memory blocks which do not have data stored therein has become the number which does not satisfy the predetermined condition (S501), data erasure does not take place while there are a sufficient number of empty blocks, so that wasteful flash erase can be avoided.

### BRIEF DESCRIPTION OF DRAWINGS

FIG. 1 is a block diagram illustrating the structure of a memory system according to one embodiment of the invention.

FIG. 2 is a diagram exemplarily showing the logical structure of the memory area of a flash memory.

FIG. 3 is a diagram exemplarily showing the data structures of a directory and FAT.

FIG. 4 is a diagram exemplarily showing the data structure of a BSI (Block Search Index).

FIG. 5 is a diagram exemplarily showing the data structure of a BPT (Block Pointer Table).

FIG. 6 is a flowchart illustrating an initialization process.

FIG. 7 is a flowchart illustrating a data reading process.

FIG. 8 is a flowchart illustrating a data writing process.

FIG. 9 is a flowchart illustrating a directory and FAT renewal process.

FIG. 10 is a flowchart illustrating an empty block securing process.

FIG. 11 is a flowchart illustrating an initialization process in case where the flash memory stores the BPT.

FIG. 12 is a flowchart illustrating a data reading process in case where the flash memory stores the BPT.

FIG. 13 is a flowchart illustrating a modified part of a data writing process in case where the flash memory stores the BPT.

FIG. 14 is a flowchart illustrating an initialization process in case where the flash memory stores the BSI.

FIG. 15 is a flowchart illustrating a modified part of a data writing process in case where the flash memory stores the BSI.

FIG. 16 is a block diagram illustrating the structure of a modification of the memory system in FIG. 1.

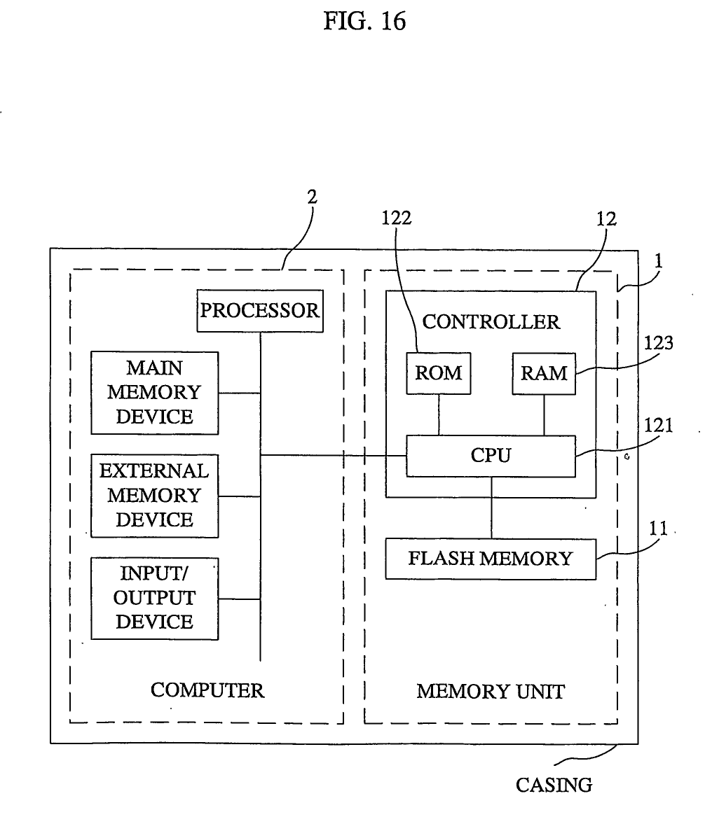

### BEST MODE FOR CARRYING OUT THE INVENTION

One embodiment of the invention will be described below, taking a memory system equipped with a flash memory as an example, with reference to the accompanying drawings.

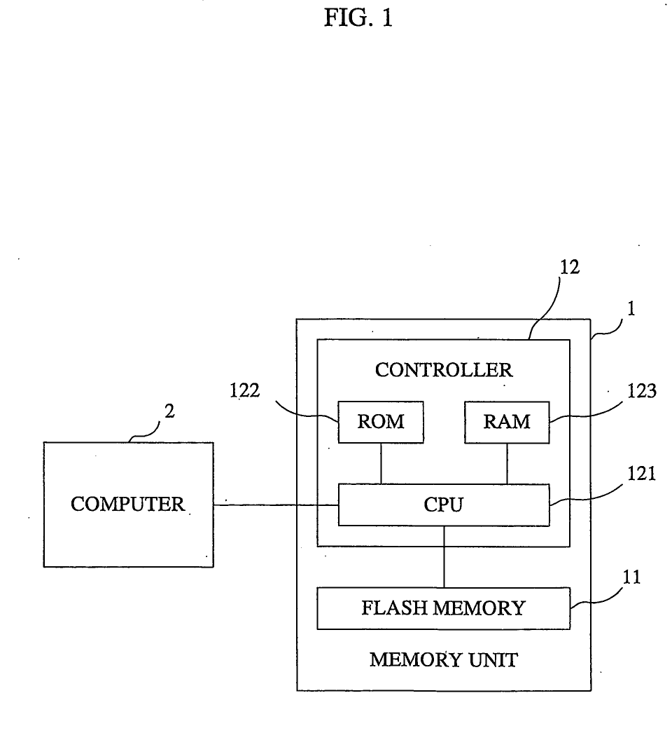

FIG. 1 is a block diagram illustrating the physical structure of the memory system according to the embodiment of the invention.

As illustrated, the memory system comprises a memory unit 1 and a computer 2. The memory unit 1 is attached in a detachable manner to the computer 2 via a slot provided in the computer 2.

The slot of the computer 2 comprises, for example, a PCMCIA slot for relaying a PCMCIA bus.

The memory unit 1 comprises a flash memory 11 and a controller 12.

The flash memory 11 is comprised of a memory device, such as EEPROM (Electrically Erasable/Programmable Read Only Memory).

In response to an access made by the controller 12, the flash memory 11 stores data supplied from the computer 2, supplies stored data to the computer 2 and erases stored data.

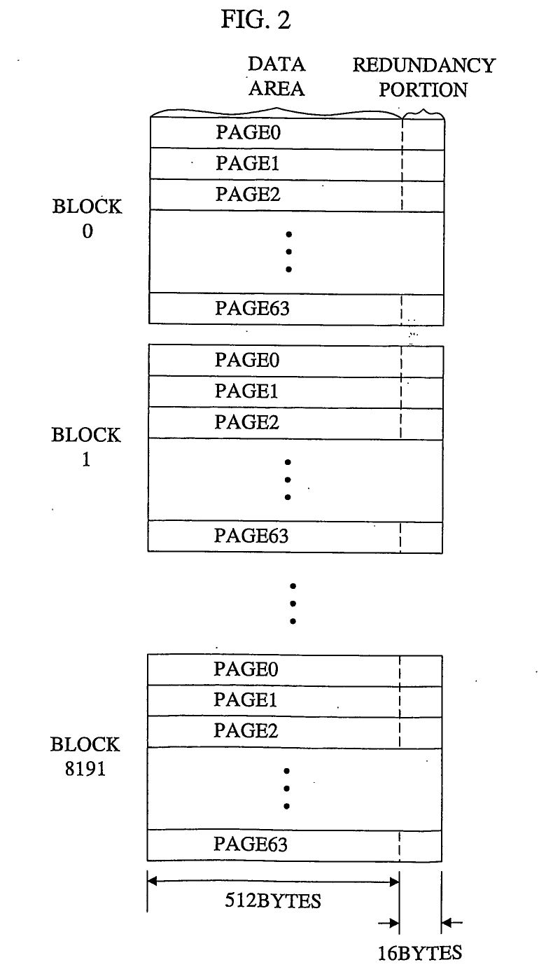

The memory area the flash memory 11 has consists of, for example, 524,288 pages as shown in FIG. 2, each page having a memory capacity of 528 bytes. Memory cells included in each page are given consecutive addresses from “0” to “527”.

As illustrated, each page consists of a data area that occupies an area of 512 bytes from the top and a redundancy portion, which occupies an end area of 16 bytes.

User data (data supplied from the computer 2 and written or data to be supplied to the computer 2) is stored in the data area

An ECC (Error Correcting Code) for checking if the contents of user data stored in the data area which belongs to the same page as the redundancy portion does are not corrupted and a defective block flag are stored in the redundancy portion.

The defective block flag is data indicating whether a block (to be discussed later) to which a page where the defective block flag is stored belongs is a block capable of properly storing data (good block), a block which is not a good block, i.e., a defective block and has been decided as defective before shipment by the manufacturer or the like of the flash memory 11 (initially defective block), or a block which is a defective block and is decided as being unable to properly store data during the use of the flash memory 11 (later-generated defective block).

It is to be noted that the defective block flag that shows a good block can be updated so as to be able to indicate a later-generated defective block when it is overwritten with a value indicating a later-generated defective block.

A NAND type flash memory can overwrite a value “0” in a memory cell storing a value “1”. (This type of flash memory cannot overwrite a value “1” in a memory cell storing a value “0” and a block including this memory cell should be flash-erased (to be discussed later) once.)

Suppose therefore that the flash memory 11 is a NAND type flash memory and the defective block flag consists of data of one byte (8 bits). In this case, provided that the defective block flag indicates that a block is a good block when the number of bits in the 8-bit data which show a value “0” is 1 or less, the flag indicates that a block is a later-generated defective block when the number of 0-showing bits is 2 or greater but 6 or small and the flag indicates that a block is an initially defective block when the number of 0-showing bits is 7 or greater, the defective block flag can be updated to show a later-generated defective block as it is overwritten with the value that indicates a later-generated defective block. This manipulation eliminates the need for flash-erasing a block, which has the defective block flag.

In case where user data stored in the data area is invalid (e.g., in case where renewed data of this user data is stored in another data area in the flash memory 11), an old data flag indicating that this data is invalid is stored in the redundancy portion which belongs to the same page as the former data area does in a process to be discussed later.

Every 64 pages starting from the top constitute a single block. Each block has a memory capacity of 32 Kbytes, and the entire memory area comprises 8,192 blocks which are given consecutive physical block addresses of “0” to “8191”. The individual pages that belong to each block are given consecutive page addresses of “0” to “63”.

The value of a logical address, which is allocated to each page, is stored in the redundancy portion of that page. The logical address is a unit that is recognized as a data reading/writing unit by the controller 12 when the flash memory 11 is read or written through an operation to be discussed later.

The logical address of a page consists of, for example, upper digits (logical block address) indicating a block to which the page belongs and lower digits (page address) indicating the location of the page in the block. The total number of logical addresses is a predetermined value, for example, 512,000, smaller than the total number of pages the flash memory 11 physically has.

When the flash memory 11 is instructed to erase data in a specific block by the controller 12 of the memory unit 1, it flash-erases the memory contents of all the memory cells that are included in the block. (Specifically, in case where the flash memory 11 is of a NAND type, the memory value of each memory cell is set to “1”.)

A directory, FAT (File Allocation Table) and write pointer initial value are stored in the data area of the flash memory 11, and are renewed by a process to be discussed later.

The page where the directory, FAT and write pointer initial value are stored is given a logical address which meets a predetermined condition. Specifically, for example, the top 4,096 addresses (i.e., addresses 00000h to 00FFFh) are given as a logical address.

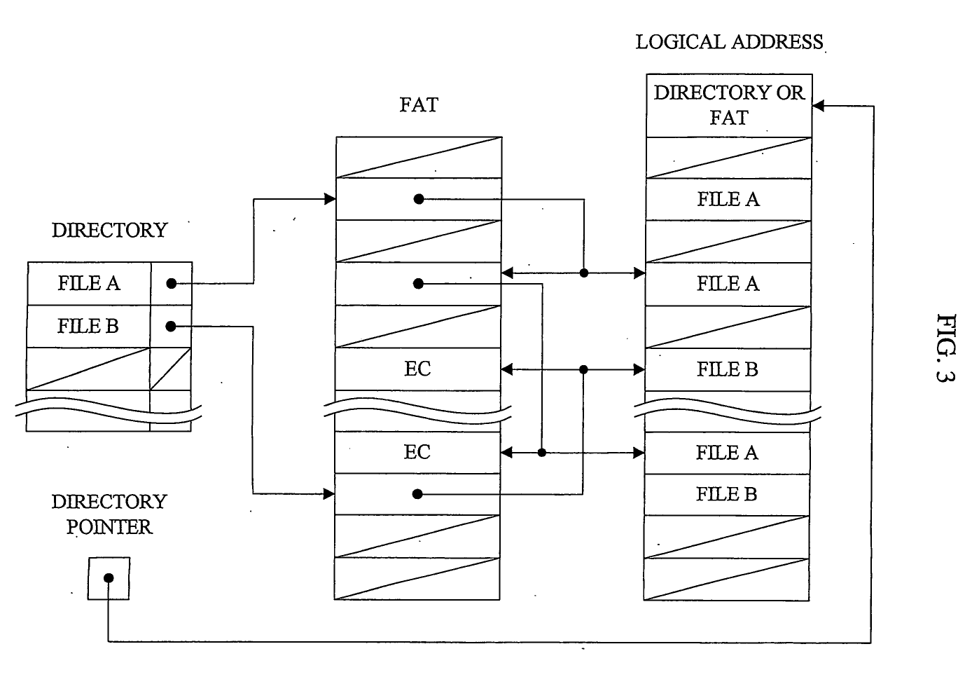

FIG. 3 is a diagram showing the correlation among the directory, FAT and logical block address. As illustrated, the logical address of the page where the directory, FAT and write pointer initial value are stored is pointed by, for example, a directory pointer stored in a CPU (Central Processing Unit) 121 (or stored in a RAM (Random Access Memory) 123 by the CPU 121).

The directory is a table showing the names of files stored in the flash memory 11 (i.e., a collection of data designated by the computer 2 as a collective target to be handled) and logical addresses where the head portions of the files are stored.

The FAT is a table indicating the layout of files in the memory area in the flash memory 11 and indicates the logical address of a page which stores a subsequent part as shown in FIG. 3 when a file does not fit in one page. The logical address of the page where the last part of a file is stored is given an end code (EC) as shown in FIG. 3 to indicate that the page address represents the last part.

The write pointer initial value represents the latest value of a write pointer (to be discussed later) which is a variable indicating a page where the CPU 121 should write user data, and designates the page where user data should be written at the time the memory system writes the user data in the flash memory 11 for the first time after having been activated.

The controller 12 has the CPU 121, a ROM (Read Only Memory) 122 and the RAM 123, as shown in FIG. 1. The RAM 123 is comprised of, for example, SRAM (Static RAM).

The CPU 121 is connected to the ROM 122, RAM 123 and flash memory 11 and is connected to the computer 2 via the PCMCIA slot provided in the computer 2.

The CPU 121 performs processes to be discussed later in accordance with processes executed by a program prestored in the ROM 122 by the manufacturer or the like of the controller 12.

When acquiring a command supplied from the computer 2 that constitutes an access device, the CPU 121 executes the command. Commands the CPU 121 executes include a command to access the flash memory 11.

The memory area the RAM 123 has is used as a work area for the CPU 121 and includes a saving memory area The memory area further stores a BSI (Block Search Index) and BPT (Block Pointer Table) which are generated by the CPU 121 in processes to be discussed later and a write pointer.

The saving memory area is a memory area to temporarily store data stored in a block which includes a page to be subjected to writing in a data writing process to be discussed later.

The BSI stores information that specifies which one of the individual blocks included in the memory area of the flash memory 11 is an empty block (i.e., a block which has been flash-erased and is no longer storing user data). The BSI is generated and renewed according to processes of the controller 12 to be discussed later.

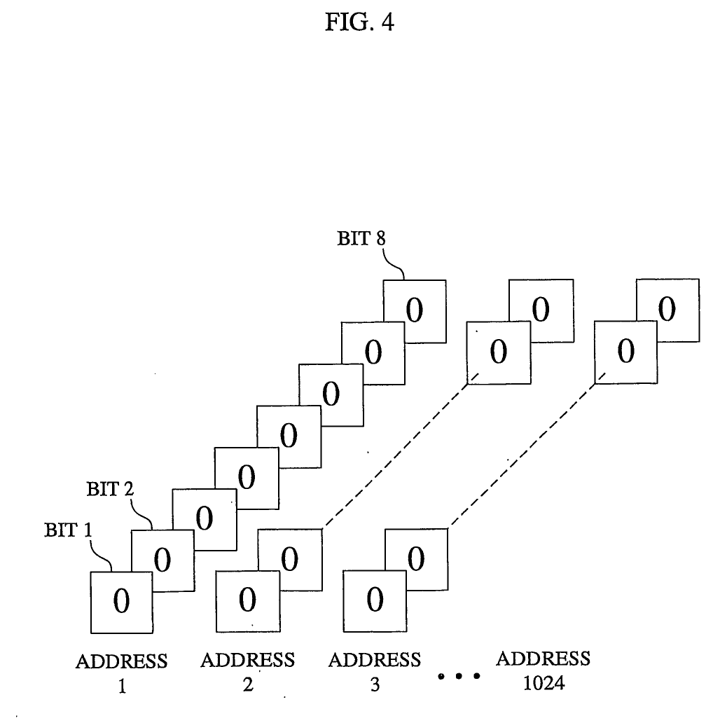

FIG. 4 shows one example of the structure of the BSI when the total number of blocks in the flash memory 11 is 8,192. As illustrated, the BSI consists of data of one Kbytes, with their bits being associated, one to one, with the first block to the 8192nd block in order from the top bit. The BSI stores “1” when the associated block is an empty block and “0” when the block is not an empty block.

The BPT stores information on each page indicating the correlation between the logical address and physical address of that page. The BPT is generated and updated by the CPU 121 in accordance with a process to be discussed later.

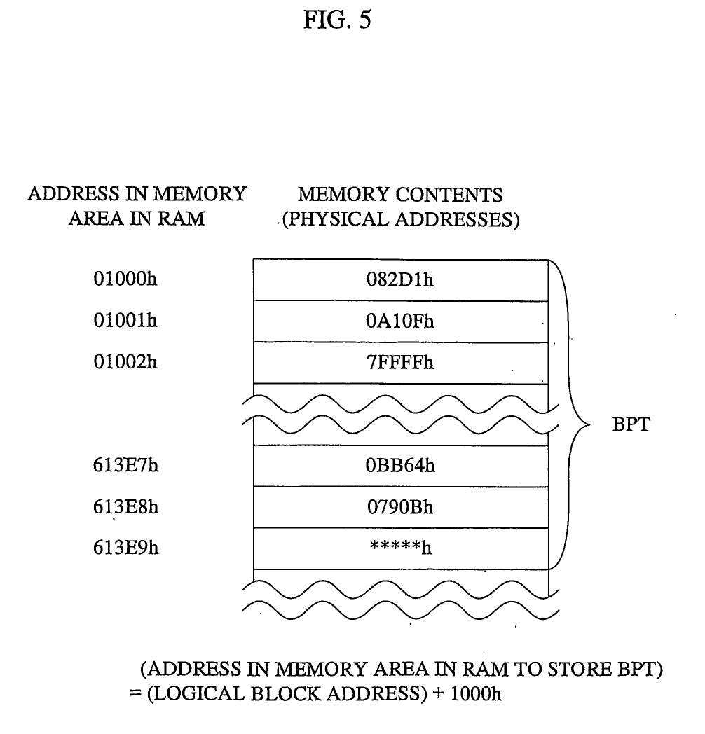

Specifically, the BPT has a data structure as shown in FIG. 5, for example.

The BPT has a memory area that occupies a predetermined logical position in the memory area in, for example, the RAM 123 and stores physical addresses associated with the respective logical addresses. Given that there are 512,000 logical addresses in total, as illustrated, the memory area of the BPT should have a size of a total of 1,216,000 bytes with addresses 01000h to 7DFFFh each given every 19 bits starting from the top.

In case where the BPT has the data structure shown in FIG. 5, each of the addresses allocated to the memory area that forms the BPT is equal to the sum of the logical address and a predetermined offset value. (FIG. 5 exemplifies the case where the offset value is “1000h”.)

The content of each 19-bit memory area to which an associated address is allocated represents the physical address (a set of a physical block address and a page address) of a page associated with the logical address indicated by the address of the 19-bit memory area.

Suppose that, as shown in FIG. 5, a value “0A10Fh” (binary value of “0001010000100001111”) is stored in the memory area allocated with the address 1001h and the offset value is “1000h”. In this case, a logical address “0001h” is associated with the page whose physical address is “0A10Fh” (the physical block address is “0284h” and the page address is “0Fh”).

In case where the content stored in a memory area allocated with an associated address represents a predetermined value (e.g., in case where the content represents the physical address value of “7FFFFh” as illustrated), no physical address is associated with the logical address indicated by the address of the memory area where the value is stored.

The write pointer is a variable (pointer) which designates a page where the CPU 121 should write user data and specifically indicates the physical address of the associated page. The value of the write pointer is updated according to a process to be discussed later.

The computer 2 is comprised of a personal computer or the like, has the PCMCIA slot, has an OS and program data, representing drivers, stored therein, and executes the OS after being powered on. When the computer 2 detects the installment of the memory unit 1 in the PCMCIA slot, it activates the drivers according to the processes of the OS.

The computer 2 which executes the processes of the drivers supplies the controller 12 with the aforementioned commands or supplies the flash memory 11 with data to be written and allows the CPU 121 to access the flash memory 11. The computer 2 acquires, from the CPU 121, data, which has been read from the flash memory 11 and supplied to the computer 2 by the CPU 121 in response to the command sent from the computer 2.

(Operation)

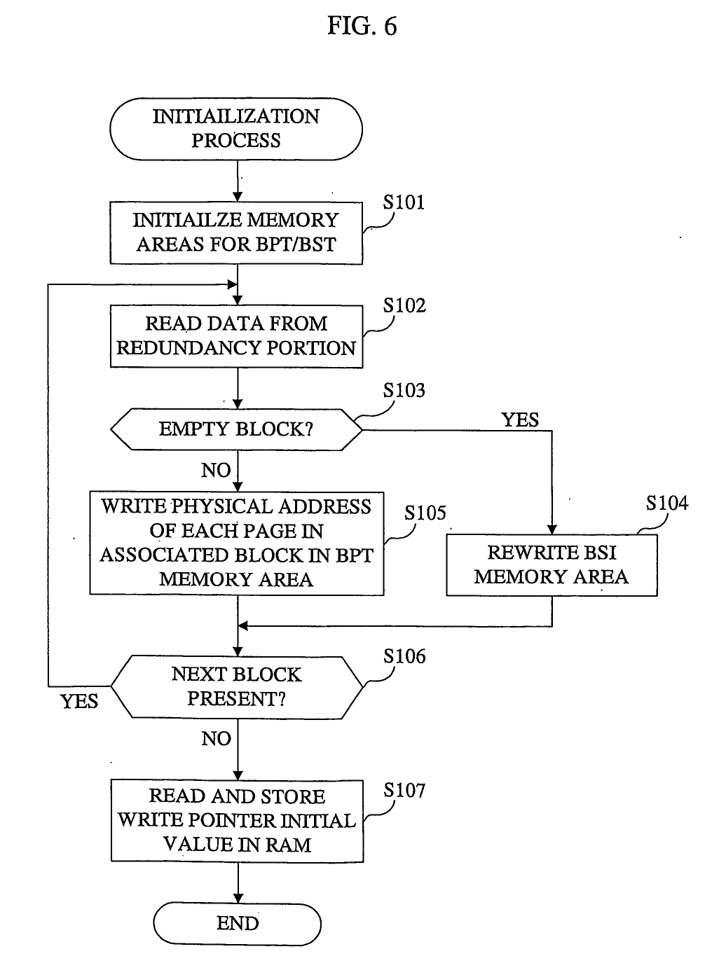

The operation of this memory system will be described below referring to FIGS. 6 to 10.

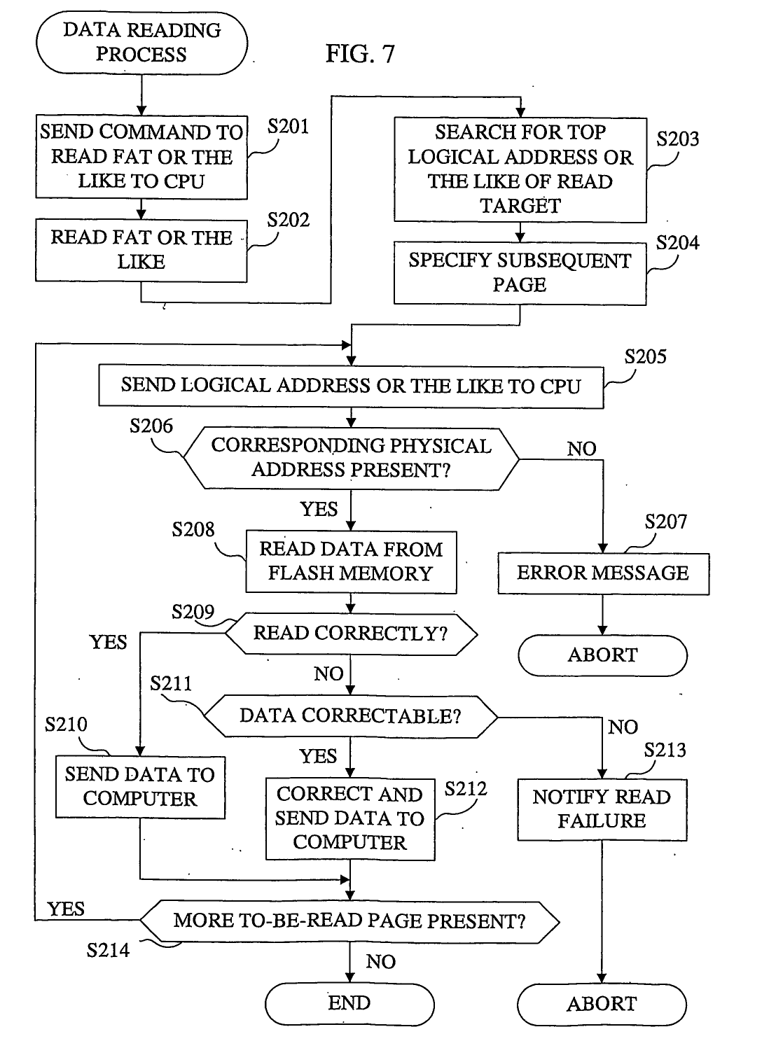

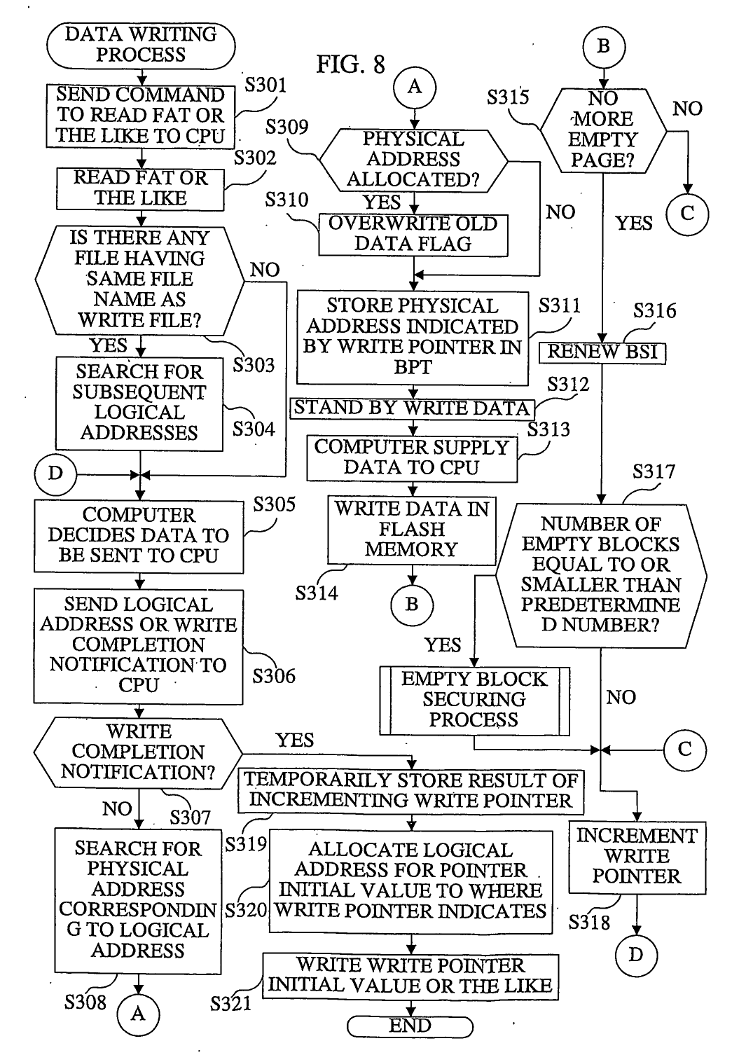

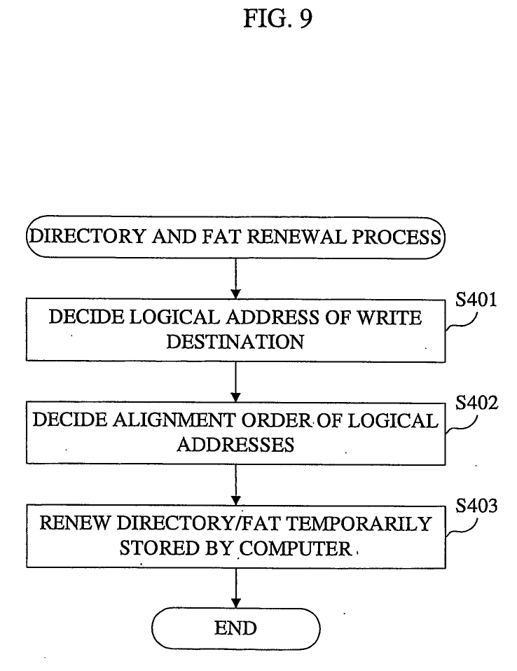

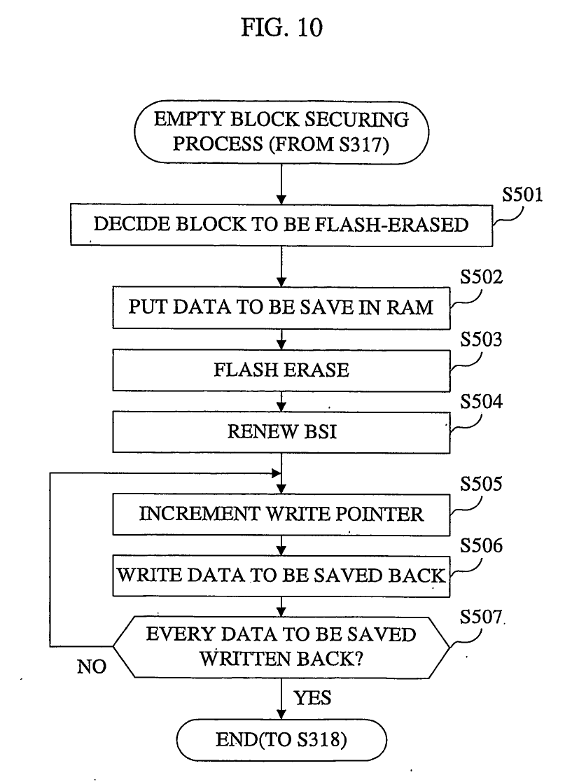

FIG. 6 is a flowchart illustrating an initialization process. FIG. 7 is a flowchart illustrating a data reading process. FIG. 8 is a flowchart illustrating a data writing process. FIG. 9 is a flowchart illustrating a directory and FAT renewal process. FIG. 10 is a flowchart illustrating an empty block securing process.

(Initialization Process)

As the memory system is activated, the CPU 121 of the controller 12 in the memory unit 1 executes the initialization process shown in FIG. 6.

As the initialization process starts, the CPU 121 initializes those portions in the memory area in the RAM 123 where the BPT and BSI are stored (step S101 in FIG. 6).

In step S101, specifically, the CPU 121 writes a predetermined value (e.g., the aforementioned value “7FFFFh”), which indicates that a physical address is not associated with each 19-bit area indicated by the aforementioned address, in that portion in the memory area in the RAM 123 where the BPT is stored. The CPU 121 sets the values of all the bits of the portion where the BSI is stored to “0”.

Next, the CPU 121 specifies a block with the youngest physical block address from among those blocks from whose redundancy portions data has not been read out yet and reads every data stored in the redundancy portions of the individual pages which belong to the specified block (step S102).

Then, based on the data read in step S102, the CPU 121 discriminates whether the block from which data has been read out in step S102 is an empty block or not (step S103). Specifically, for example, the CPU 121 discriminates whether the data read out in step S102 is an empty block code (e.g., the aforementioned “7FFFFh”) of a predetermined format or not. When the CPU 121 discriminates that the read block is not an empty block, the CPU 121 moves the process to step S105.

When the CPU 121 discriminates in step S103 that the read block is an empty block, the CPU 121 computes, from the physical block address indicating the block, the position in the memory area of the RAM 123 where the bit in the BSI which indicates the status of the block occupies. Then, the CPU 121 rewrites the value of the position-computed bit with “1” (step S104). When the process of step S104 is done, the CPU 121 moves the process to step S106.

Meantime, in step S105, the CPU 121 writes the physical address of each page whose logical address has been read out from the flash memory 11 in the memory area of the RAM 123. The logical position (in the RAM 123) where the CPU 121 writes the physical address of the page in step S105 is the portion to which an address equivalent to the logical address read from that page is given. Accordingly, new information indicating the correlation between the physical address and the logical address is added to the BPT.

When completing the process of step S105 for all the logical addresses read from the same block in the flash memory 11, the CPU 121 moves the process to step S106.

In step S106, the CPU 121 discriminates whether or not there is a next block to the block from whose redundancy portion data has been read out in step S102. The CPU 121 returns the process to step S102 when having discriminated that there is a next block, but moves the process to step S107 when having discriminated that there is no next block.

In step S107, the CPU 121 accesses a page where the write pointer initial value is stored, reads the write pointer initial value and stores the value in the RAM 123, after which the CPU 121 terminates the initialization process.

Through the above-described initialization process, the BSI and BPT are generated and the write pointer initial value is specified.

(Data Reading Process)

As the initialization process is completed, the CPU 121 in the memory unit 1 accepts an instruction to access the flash memory 11 from the computer 2.

To instruct the CPU 121 to read data from the flash memory 11, the computer 2 first supplies the CPU 121 with a read command to read a directory and FAT and the logical address of each page where the directory and FAT are stored (step S201 in FIG. 7).

The CPU 121, supplied with the command to read data and the logical address, searches the BPT for the physical address of each page where the directory and FAT are stored with the logical address as a key, reads data constituting the directory and FAT from each page indicated by the searched physical address and supplies the data to the computer 2 (step S202). The computer 2 temporarily stores the directory and FAT supplied from the CPU 121.

Next, to search for the logical address of the top page where the file content which has the file name of a file containing to-be-read data is stored, the computer 2 searches the directory, supplied from the CPU 121 and temporarily stored, with the file name as a key (step S203).

Next, with the logical address searched in step S203 as a key, the computer 2 searches the FAT supplied from the CPU 121 to retrieve all logical addresses of pages, if present, which follow the page whose logical address has been retrieved, and specifies the consecutive order of the pages (step S204).

Then, to read the memory contents of the pages retrieved in steps S203 and S204, the computer 2 supplies the CPU 121 with a read command and the logical address of that page from which user data should be read out (i.e., the top one of the pages which have been retrieved in steps S203 and S204 and from which data has not been read out yet) (step S205).

When supplied with the read command and the logical address in step S205, the CPU 121 accesses the RAM 123 and searches the BPT with the logical address supplied from the computer 2 in step S205 as a key to discriminate whether or not there is a physical address associated with the logical address (step S206).

When having discriminated that there is no such a physical address, the CPU 121 supplies an error message (e.g., a predetermined “FFh”) to the computer 2 (step S207) and terminates the data reading process (abort).

When having discriminated that there is such a physical address, the CPU 121 reads data from the page indicted by the physical address (step S208). Then, the CPU 121 generates an ECC based on that data in the read data which is stored in the data area and discriminates whether or not the data stored in the data area has been read out correctly, based on the generated ECC and an ECC in the read data which has been stored in the redundancy portion (step S209).

When having discriminated in step S209 that the data was read out correctly, the CPU 121 supplies data stored in the data area to the computer 2 (step S210).

When having discriminated that the data was not read out correctly, the CPU 121 discriminates whether or not the data stored in the data area can be corrected to the correct content based on the ECC or the like stored in the redundancy portion (step S211). When having discriminated that data restoration would be possible, the CPU 121 corrects the data stored in the data area and supplies the corrected data to the computer 2 (step S212).

When having discriminated in step S211 that correction would not be possible, the CPU 121 overwrites the defective block flag stored in the redundancy portion of the page from which the uncorrectable data has been read (or the redundancy portion of another arbitrary page in the same block to which the former page belongs with a value representing a later-generated defective block and notifies the computer 2 of failure of data reading (S213). Upon reception of the notification, the computer 2 interrupts the data reading process (abort).

When the computer 2 receives to-be-read data from the CPU 121 in step S210 or S212, the computer 2 discriminates whether or not there is any page remaining from which user data should be read out (step S214). Then, the computer 2 returns the process to step S205 when having discriminated that there is such a page remaining, and terminates the process when having discriminated that there remains no such a page.

Through the above-described processes of steps S201 to S214, data is read from the flash memory 11 and supplied to the computer 2.

(Data Writing Process)

In case of writing data in the flash memory 11, first, to read a directory and FAT, the computer 2 first supplies the CPU 121 with a read command and the logical address of each page where the directory and FAT are stored as done in the step S201 (step S301 in FIG. 8). It is to be noted however that in case where the directory and FAT have temporarily been stored already for some purpose, such as reading data, the process of step S301 is omitted and the data writing process starts at step S303.

The CPU 121, supplied with the command to read data and the logical address, performs substantially the same process as that of the step S202 to read the directory and FAT and supplies them to the computer 2 (step S302). The computer 2 temporarily stores the directory and FAT supplied from the CPU 121.

Next, with the file name of the file to be written in the flash memory 11 as a key, the computer 2 searches the directory supplied from the CPU 121 and discriminates whether or not the file name is stored in the directory (step S303). When the decision is negative, the computer 2 moves the process to step S305 to be discussed later.

When the decision in step S303 is affirmative, on the other hand, the computer 2 searches the FAT supplied from the CPU 121 using the logical address, associated with the file name retrieved in the searching in step S303, as a key. Then, the computer 2 retrieves the logical address of each page which holds data indicated by the file name and temporarily stores the logical address (step S304), and moves the process to step S305.

In step S305, the computer 2 decides data to be supplied to the CPU 121 in steps S306 and S313 to be discussed later.

Specifically, in step S305, the computer 2 first discriminates whether or not writing of the to-be-written file has been completed. When the decision is negative, the computer 2 decides to supply one page of data which is included in data contained in the to-be-written file and which has not been written in the flash memory 11 yet in step S313 and decide to supply the logical address (the logical address of the write destination) of the page that holds this data in step S306.

When having discriminated that writing of the to-be-written file has been completed, on the other hand, the computer 2 discriminates whether or not the directory and FAT, temporarily stored therein, have been written in the flash memory 11. When having discriminated that the writing has not been finished, the computer 2 decides to supply one page of data constituting the directory and FAT, temporarily stored in the computer 2, in step S313 and decide the logical address (the logical address of the write destination) of the page where the directory and FAT should be stored.

When the computer 2 has discriminated that writing of the directory and FAT has been completed too, the computer 2 decides to supply predetermined data to notify the completion of the writing in step S306.

In step S306, the computer 2 supplies the logical address of the to-be-written page to store data or notification of the completion of writing in accordance with the result of the decision made in step S305. In case of supplying the logical address, the computer 2 also supplies a command to write one page of data in the flash memory 11.

In case where the computer 2 has decided to supply data contained in the to-be-written file in step S313, the computer 2 executes the directory and FAT renewal process shown in FIG. 9 to decide the logical address to be supplied to the CPU 121 in step S306 and renewal of the directory and FAT.

That is, the computer 2 first analyzes the directory and FAT temporarily stored therein and specifies logical addresses of pages where data is not written (i.e., the logical addresses which are not associated with the file name) by the quantity required for storing to-be-written data as logical addresses that should be allocated to the to-be-written pages (step S401 in FIG. 9).

When having discriminated in step S303 that the file name of the to-be-written file is included in the directory, the computer 2 may specify the logical address associated with this file name (i.e., the logical address temporarily stored in step S304) by priority as the logical address of the page where data is to be written.

Next, the computer 2 decides the aligning order of the individual logical addresses specified in step S401 (step S402). This aligning order represents the aligning order of the individual pages to which those logical addresses are allocated and represents the aligning order of data written in those pages.

When the computer 2 has carried out the processes of steps S401 and S402, the controller 12 has only to supply the CPU 121 with the logical address which is included in those logical addresses specified in step S401 and not having supplied to the CPU 121 yet and which corresponds to the top in the aligning order decided in step S402.

Next, the computer 2 stores the logical address specified in step S401 in the directory and FAT, temporarily stored in the computer 2, in such a way as to take the data structure shown in FIG. 3 (step S403). The relationship between addresses precedent and subsequent to the logical address represented by the directory and FAT should match the order specified in step S401. The process of step S403 generates a directory and FAT to be newly written in the flash memory 11.

When the CPU 121 is supplied with data, such as the logical address of the write destination or notification of completion of writing, from the computer 2 in step S306, the CPU 121 discriminates whether or not notification of completion of writing is included in those data (step S307 in FIG. 8). The CPU 121 moves the process to step S319 when the decision is affirmative and carries out processes starting at step S308 when the decision is negative.

In step S308, the CPU 121 accesses the RAM 123 and searches the BPT for the physical address of the page that is indicated by the logical address supplied from the computer 2.

Next, the CPU 121 discriminates whether or not the physical address has been retrieved in step S308 (step S309) and moves the process to step S311 when the decision is negative.

When having discriminated in step S309 that the physical address has been retrieved, the CPU 121 accesses the flash memory 11, overwrites the old data flag in the redundancy portion of the page to which the retrieved physical address is allocated (step S310), and moves the process to step S311. In step S310, the CPU 121 accesses the RAM 123 and renews the physical address specified in step S308 to a value indicating that the physical address has not been associated yet (e.g., the aforementioned value “7FFFh”). That is, the allocation of the logical address to this page is relieved.

Next, the CPU 121 accesses the RAM 123 and stores the physical address currently pointed by the write pointer in the BPT in such a form as to be associated with the logical address of the write destination supplied from the computer 2 (step S311). Then, the CPU 121 stands by for the supply of one page of data to be written in the flash memory 11 from the computer 2 (step S312).

When data to be written in the flash memory 11 is supplied from the computer 2 (step S313), the CPU 121 accesses the flash memory 11 and writes one page of data supplied from the computer 2 in the page that is currently pointed by the write pointer (step S314). In step S314, the CPU 121 writes the logical address supplied from the computer 2 in step S306 in the redundancy portion of that page.

Next, the CPU 121 accesses the RAM 123 and discriminates whether or not the page in which data has been newly written in step S314 is the end page of the block based on, for example, the current value of the write pointer (step S315). (Specifically, for example, it should be discriminated whether or not the value of the lower 6 bits of the current value of the write pointer is “3Fh”.) When having discriminated that the page in question is not the endpage, the CPU 121 moves the process to step 8318.

When having discriminated in step S315 that the page where data has been newly written is the end page, on the other hand, the CPU 121 renews the content of the BSI stored in the RAM 123 in such a way as to indicate that this block is not an empty block (step S316).

Next, the CPU 121 counts the number of current empty blocks based on the content of the BSI and discriminates whether or not the number of the empty blocks is equal to or smaller than a predetermined value (e.g., two) (step S317). When having discriminated that the number of the empty blocks is greater than the predetermined value, the CPU 121 moves the process to step S318.

When having discriminated that the number of the empty blocks is equal to or smaller than the predetermined value, the CPU 121 initiates the empty block securing process shown in FIG. 10.

As the empty block securing process starts, the CPU 121 specifies one or more blocks from which data is to be erased to turn them to empty blocks (step S501 in FIG. 10). Then, the CPU 121 reads data (data to be saved) stored in that one of individual pages in each specified block in whose redundancy portion the old data flag is not stored, including data stored in the redundancy portion, and stores the data in the RAM 123 (step S502).

The reference for determining a block to be flash-erased by the CPU 121 in step S501 is set arbitrarily; for example, the CPU 121 has only to determine, as a target to be flash-erased, a non-empty block (a block other than an empty block) which is included in those blocks subsequent to the latest block that has been flash-erased to become an empty block (i.e., blocks that are given physical block addresses larger than the physical block address of the latest block) and which has the smallest physical block address. In case where there is no such a non-empty block, however, that one of all the non-empty blocks in the flash memory 11 which has the smallest physical block address is to be flash-erased.

As a block to be flash-erased is decided in this manner, the flash erase target is cyclically designated in the order of physical block addresses, which are substantially cyclically ordered. With a block to be flash-erased being decided this way, every time the process of step S501 is executed, the non-empty block that has the oldest written content is specified as one to be flash-erased.

Next, the CPU 121 flash-erases the block specified in step S501 to turn it to an empty block and writes an empty block code in each page in the block that has just become an empty block (step S503). (It is to be noted however that in case where the flash memory 11 is of a NAND type and the empty block code consists only of bits which have values of “1”, it is not particularly necessary to execute the operation of writing the empty block code.)

The CPU 121 accesses the RAM 123 and renews the content of the BSI in such a way as to indicate that this block is an empty block (step S504).

Next, the CPU 121 increments the write pointer (step S505). For example, the CPU 121 specifies the top one of those pages, which follow the page currently, pointed by the write pointer and have no logical addresses written. Then, the CPU 121 renews the value of the write pointer stored in the RAM 123 in such a way as to point the physical address of the specified page. In case where the page currently pointed by the write pointer is the end page of the block, however, the CPU 121 should search the BSI to specific a new single empty block, specify the top page of the specified empty block and renew the value of the write pointer stored in the RAM 123 in such a way as to point the physical address the specified top page in step S505.

Next, the CPU 121 writes to-be-saved data back (step S506). That is, of those pieces of to-be-saved data stored in the RAM 123 in step S502, one page of data which has not been written back into the flash memory 11 is written in the page that is currently pointed by the write pointer. The CPU 121 may erase that portion of the to-be-saved data, which has been written back into the flash memory 11 from the memory area of the RAM 123.

Next, the CPU 121 discriminates whether or not every to-be-saved data has been written back (step S507) and returns the process to step S505 when having discriminated that some to-be-saved data has not been written back.

When having discriminated in step S507 that every to-be-saved data has been written back, the CPU 121 terminates the empty block securing process and increments the write pointer in the same way as done in the process of step S505 (step S318) and stands by for the supply of the logical address of the next write destination or notification of completion of writing from the computer 2.

As the CPU 121 goes to the mode to sand by for the supply of the logical address of the next write destination or notification of completion of writing from the computer 2, the computer 2 returns the process to step S305. Then, when the logical address of the next write destination or notification of completion of writing from the computer 2 is supplied from the computer 2 in step S306, the CPU 121 returns the process to step S307.

As the CPU 121 moves the process to step S319 upon reception of the notification of completion of writing, the CPU 121 performs a process similar to the process of step S505 to acquire the result of incrementing the current value of the write pointer stored in the RAM 123 and temporarily stores the result It is to be noted that the write pointer does not increment itself.

Next, the CPU 121 stores the physical address currently pointed by the write pointer in the BPT in such a form as to be associated with the physical address (the logical address for the pointer initial value) that is given to the page where the write pointer initial value is stored (step S320).

Next, the CPU 121 writes the value obtained in step S319 as the write pointer initial value in the data area of the page currently pointed by the write pointer (step S321). In step S321, the logical address for the pointer initial value is written in the redundancy portion of this page.

When the process of step S321 is finished, the memory system terminates the data writing process.

Through the above-described processes, data supplied from the computer 2 is stored in the flash memory 11. The content of the BSI is changed in such a way as to indicate an empty block which has been newly generated as a result of writing data and indicate a vanished empty block. Meantime, the content of the BPT is also changed and the logical address that has been allocated to the page that does not have the old data flag in that block which has newly become an empty block is newly allocated to that page whose content has been transferred.

Because writing of user data is carried out page by page in this memory system, it becomes unnecessary to execute the operation of searching for a new empty block and writing user data therein every time the user data is written. This memory system does not therefore require that inefficient flash erase to be performed on a block at the time of rewriting the user data and makes the degrading of the flash memory 11 harder.

As the memory system does not flash-erase blocks while there are sufficient empty blocks, wasteful flash erase can be avoided. This feature also contributes to prevention of quicker degrading of the flash memory 11.

As the individual blocks are flash-erased in the order from oldest written data to younger one, the frequency of flash erase of the blocks becomes even. This can prevent the concentrated deterioration of a specific memory block, which would otherwise shorten the life of the entire flash memory 11.

Because pages where data is to be written are designated in the order of physical addresses by the write pointer, concentrated writing into a specific memory block can be avoid. This can prevent the execution of flash erase from being concentrated onto the writing-concentrated memory block. This feature also contributes to prevention of quicker degrading of the flash memory 11.

The structure of the memory system is not limited to the one described above.

For example, the number of blocks in the memory area of the flash memory 11, the number of pages per block, the memory capacity of each page and the memory capacities of the data area and redundancy portion are all arbitrary. Further, the flash memory 11 should not necessarily be constituted by an EEPROM but may be any memory device readable and writable by a computer.

The logical addresses of pages where the directory and FAT are stored need not take the aforementioned value, and the number of pages where the directory and FAT are stored is arbitrary.

The RAM 123 may be a non-volatile memory constituted by, for example, FeRAM (Ferroelectric RAM). In this case, the memory system may not require the initialization process if the BSI and BPT have already been stored in the RAM 123. That is, the BPT and BSI should not necessarily be generated every time the memory system is activated.

The CPU 121 should not necessarily be connected to the computer 2 via the PCMCIA slot but may be connected to the computer 2 via an IEEE 1394 interface or USB (Universal Serial Bus) or any other interface. The CPU 121 should not necessarily be connected to the computer 2 by a cable but may wirelessly be connected to the computer 2 via an interface, which conforms to the standards, such as Bluetooth (registered trademark).

The CPU 121 should not necessarily execute the process of writing the old data flag in the flash memory 11.

In this case, to specify to-be-saved data in step S502, the CPU 121 may discriminate whether or not the physical address of each page in the block specified in step S501 coincides with the physical address associated by the BPT with the logical address stored in the redundancy portion of the page, instead of referring to the old data flag. Then, data that is stored in the page for which the two physical addresses match with each other should be specified as to-be-saved data.

The BPT need not store all the digits of a physical address but may store, for example, only predetermined upper digits of the physical address or only predetermined lower digits thereof as a temporary physical address.

If the BPT stores such a temporary physical address instead of all the digits of the physical address, the amount of data on the BPT becomes smaller than the one required when the BPT stores all the digits of the physical address. Therefore, the required memory capacity of the RAM 123 to store the BPT becomes smaller, thus making it possible to design the memory system more compact.

In case where the temporary physical address consists of only predetermined upper bits of a physical address, to specify a page which has a file whose data is to be read or written, the CPU 121 refers to the BPT and specifies the temporary physical address (upper digits of the physical address) associated with the logical address of this page first. Next, the CPU 121 accesses the flash memory 11 and specifies that page which is in those pages the upper digits of whose physical addresses match with the specified temporary physical address and where the old data flag is not stored and which has theological address stored in its redundancy portion. The specified page is the page that contains a file, which is subjected to data reading and writing.

In case where the temporary physical address consists of only predetermined upper bits of a physical address, there may be a scheme of specifying a page where there is a file to be subjected to data reading and writing without using the old data flag.

Specifically, after specifying the temporary physical address (the upper digits of the physical address) of the page by referring to the BPT, the CPU 121 accesses the flash memory 11. Then, the CPU 121 specifies that page which is in those pages the upper digits of whose physical addresses match with the specified temporary physical address and where the logical address is stored in their redundancy portions and which has the largest physical address. The specified page is the page that is subjected to data reading and writing.

As the write pointer is incremented every time data is written in a page, that page which is in those pages the upper digits of whose physical addresses match with the temporary physical address and where the logical address is stored in their redundancy portions and which has the largest physical address can be said to be a page to which the logical address is allocated at present.

In case where the temporary physical address consists of only predetermined upper bits of a physical address, for example, pages in the flash memory 11 should be classified into any of plural zones and the upper digits of the physical address excluding the predetermined lower digits should indicate a zone to which the associated page belong. The size of the memory capacity of each zone may be greater or smaller than the size of each block or equal to the size of a single block. The boundary between zones may, or may not, coincide with the boundary between blocks.

In case where pages are classified into any of plural zones, each logical address should be allocated to that page which belongs to any one of the zones. Based on the logical address given to each page, therefore, the zone to which the page belongs can be specified.

In case where pages are classified into any of plural zones, to specify a page which contains a file to be subjected to data reading and writing, the CPU 121 refers to the BPT to specify the temporary physical address (lower digits of the physical address) associated with the logical address of this page and specifies the zone to which the page belongs based on the logical address. Next, based on the specified zone and temporary physical address, the CPU 121 specifies the physical address of this page and accesses the page indicated by the specified physical address.

The memory system may be modified in such a way that the flash memory 11 stores the BPT. In this case, the CPU 121 may allow the RAM 123 to store a BPT page list, which indicates the position of a page where data constituting the BPT, is stored (hereinafter called “BPT-stored page”).

Specifically, the BPT page list is comprised of, for example, a table which stores the logical. address of the BPT-stored page (hereinafter called “BPT page pointer”) and the physical address of the BPT-stored page in association with each other. At the time of storing a part of the BPT in the BPT-stored page, the CPU 121 stores the BPT page pointer, allocated to the BPT-stored page, in the redundancy portion of the BPT-stored page, for example.

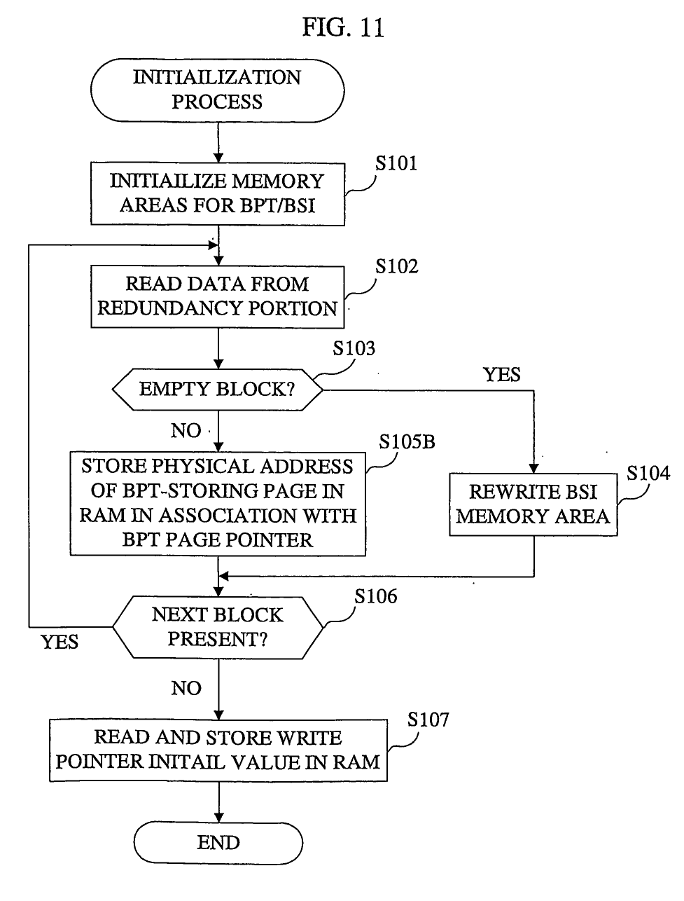

In case where the flash memory 11 has the BPT stored therein, the CPU 121 executes an operation of generating the BPT page list in the initialization process in place of the operation of generating the BPT, as shown in FIG. 11.

That is, the CPU 121 performs an operation of storing the BPT page pointer, read from the flash memory 11, and the physical address of the page (BPT-stored page) from which the BPT page pointer has been read in the RAM 123 in association with each other (step S105B in FIG. 11) instead of the process of the step S105 in FIG. 6. This operation generates the BPT page list.

In case where the RAM 123 in this memory system is constituted by a non-volatile memory and has already stored the BPT page list, the process of step S105B may be omitted.

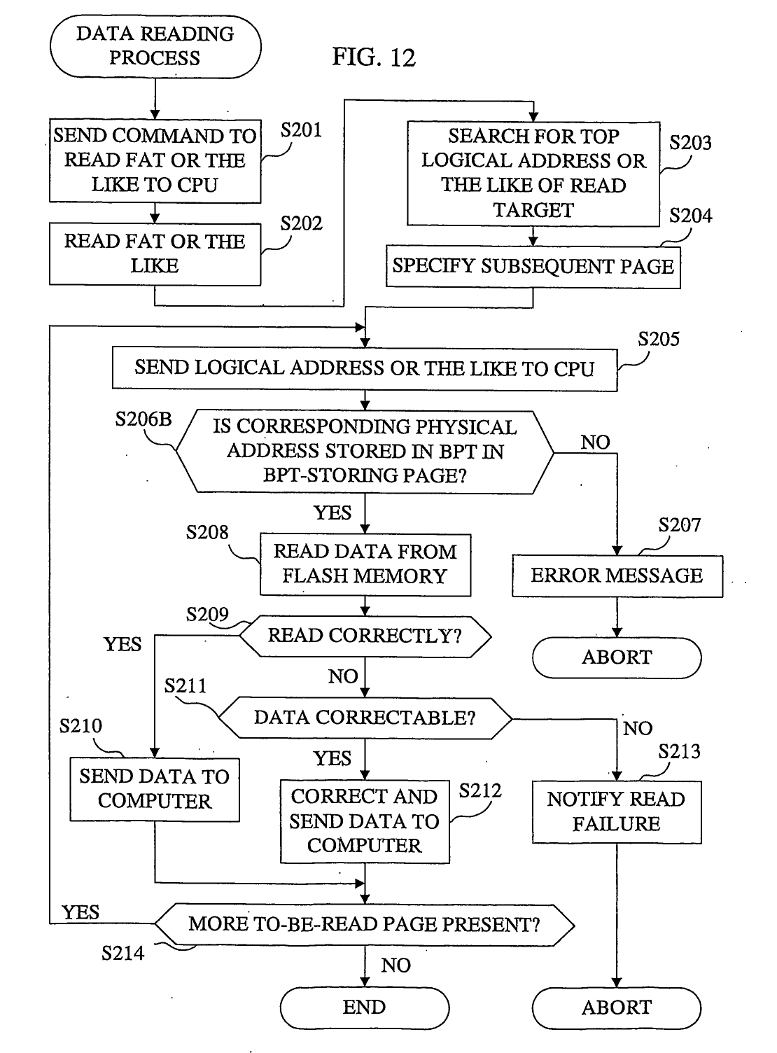

In case where the RAM 123 has the BPT page list stored therein, the CPU 121 refers to the BPT in the data reading process and thus performs the process of step S206B shown in FIG. 12 instead of the process of step S206 in FIG. 7. That is, the CPU 121 reads out the BPT page list from the RAM 123, specifies the physical address of the BPT-stored page based on the BPT page list, accesses the page that is indicated by the specified physical address to read the content of the BPT, and specifies the physical address using the read BPT.

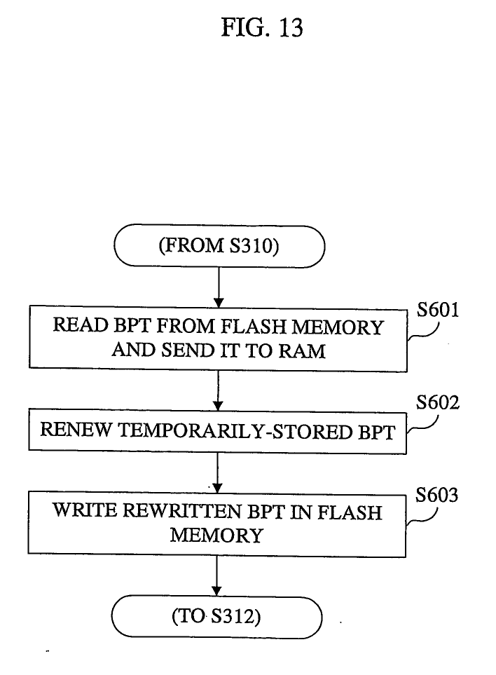

In case where the RAM 123 has the BPT stored therein, to renew the content of the BPT in the data writing process or the like, the CPU 121 executes the processes of steps S601 to S603 shown in FIG. 13 in place of the process of the step S311.

That is, first, the CPU 121 executes processes similar to the processes of steps S205 to S214 to read the BPT from the flash memory 11 and temporarily store the BPT in the RAM 123 (step S601).

It is to be understood that in step S601, the CPU 121 reads the BPT page pointer (i.e., the physical address the BPT-stored page) stored in the BPT page list from the RAM 123 instead of acquiring the logical address of a page from which user data should be read from the computer 2 and acquiring the physical address by searching the BPT. Further, instead of the computer 2 executing the process of step S214, the CPU 121 discriminates whether or not there remains any BPT-stored page from which data constituting the BPT has not been read out yet.

Next, the CPU 121 renews the content of the BPT temporarily stored in the RAM 123 by executing a process substantially the same as the process of the step S311 (step S602).

Next, the CPU 121 writes the BPTs that have been rewritten, page by page, in accordance with the processes of the steps S314 to S318 (step S603). It is to be noted that the physical address of the page which has become a new BPT-stored page as one page of data which is a part of the BPT is written in that page is registered in the BPT page list instead of being registered in the BPT.

Specifically, in step S603, the CPU 121 stores the physical address currently pointed by the write pointer in the BPT page list in such a form as to be associated with the BPT page pointer which has been allocated before the renewal of the newly-written part of the BPT. The physical address that has been associated with the BPT page pointer so far is deleted from the BPT page list.

In case where data constituting the BPT is stored only in a predetermined zone in the aforementioned zones, instead of the physical address of the BPT-stored page storing this data, the aforementioned temporary physical address indicating the position of the BPT-stored page in the zone may be stored in the BPT page list.

If the BPT page list stores the temporary physical address instead of the entire digits of the physical address of the BPT-stored page, the amount of data of the BPT page list becomes smaller than the one in the case of storing the entire digits of the physical address. This can reduce the required memory capacity of the RAM 123, so that the memory system can be constructed compact.

The BPT page pointer associated with the BPT-stored page may take such a value as to designate the logical address in which range of the BPT data stored in the BPT-stored page designates is.

In this case, in step S601, the CPU 121 may specify that part of the BPT which includes the logical address of a page including the content of a file to be subjected to reading and writing, based on the content of the BPT page list, read only the specified part from the flash memory 11 and temporarily store the read part in the RAM 123. Processes of steps S602 and S603 to be discussed later should be carried out by treating the temporarily-stored part as the BPT. Executing such processes eliminates the need for the operation of reading the entire BPT from the flash memory 11 every time the BPT is referred to, thus shortening the time required to refer to the BPT.

The memory system may be modified in such a way that the flash memory 11 stores the BSI. In this case, the CPU 121 may allow the RAM 123 to store a BSI page pointer table, which indicates the position of a page where data constituting the BSI is, stored (hereinafter called “BSI-stored page”).

Specifically, the BSI page list is comprised of, for example, a table which stores the logical address of the BSI-stored page (hereinafter called “BSI page pointer”) and the physical address of the BSI-stored page in association with each other. At the time of storing a part of the BSI in the BSI-stored page, the CPU 121 stores the BSI page pointer, allocated to the BSI-stored page, in the redundancy portion of the BSI-stored page, for example.

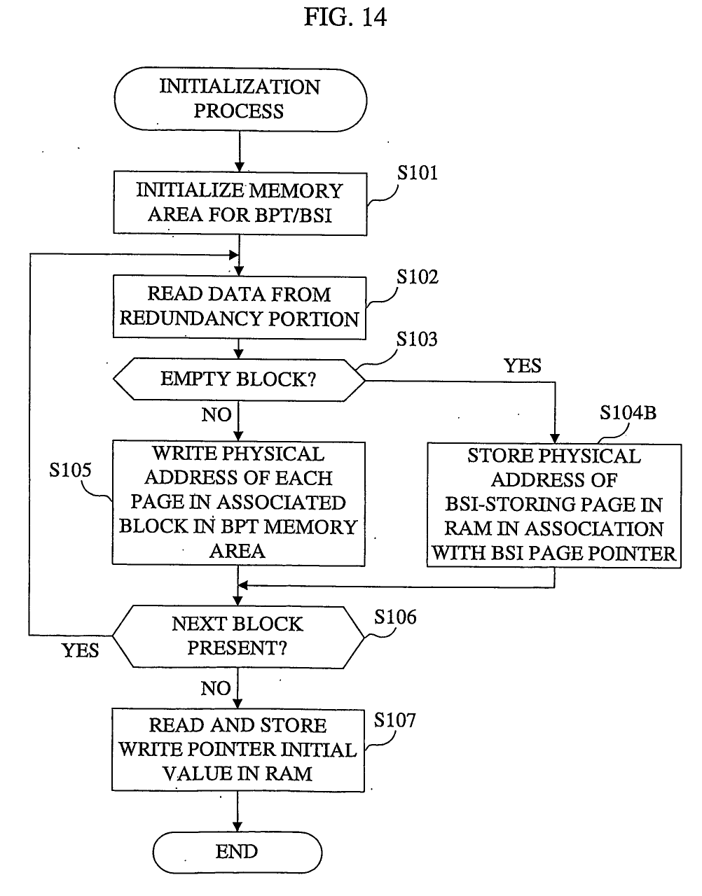

In case where the flash memory 11 has the BSI stored therein, the CPU 121 executes an operation of generating the BSI page list in the initialization process in place of the operation of generating the BSI, as shown in FIG. 14.

That is, the CPU 121 performs an operation of storing the BSI page pointer, read from the flash memory 11, and the physical address of the page (BSI-stored page) from which the BSI page pointer has been read in the RAM 123 in association with each other (step S104B) instead of the process of the step S104 in FIG. 6. This operation generates the BSI page list.

In case where the RAM 123 in this memory system is constituted by a non-volatile memory and has already stored the BSI page pointer table, the process of step S104B may be omitted.

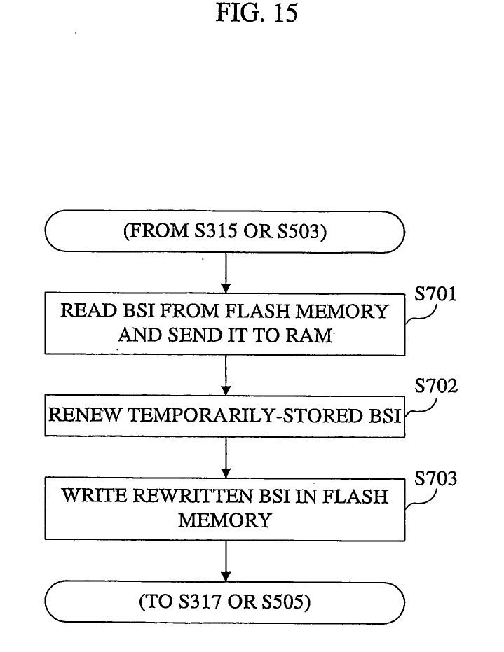

In case where the RAM 123 has the BSI stored therein, to renew the content of the BSI in the data writing process or the like, the CPU 121 executes the processes of steps S701 to S703 shown in FIG. 15 instead of the process of the step S316 or S504.

That is, first, the CPU 121 executes processes similar to the processes of steps S205 to S214 to read the BSI from the flash memory 11 and temporarily store the BSI in the RAM 123 (step S701 in FIG. 15).

It is to be understood that in step S701, the CPU 121 reads the BSI page pointer stored in the BSI page pointer table from the RAM 123 instead of acquiring the logical address of a page from which user data should be read from the computer 2 and acquiring the physical address by searching the BSI. Further, instead of the computer 2 executing the process of step S214, the CPU 121 discriminates whether or not there remains any BSI-stored page from which data constituting the BSI has not been read out yet.

Next, the CPU 121 renews the content of the BSI temporarily stored in the RAM 123 by executing a process substantially the same as the process of the step S316 (or S504) (step S702).

Next, the CPU 121 writes the BSIs that have been rewritten, page by page, in accordance with the processes of the steps S314 to S318 (step S703). It is to be noted that the physical address of the page which has become a new BSI-stored page as one page of data which is a part of the BSI is written in that page is registered in the BSI page pointer table instead of being registered in the BSI and the physical address associated with the BSI page pointer so far is deleted from the BSI page pointer table.

In case where data constituting the BSI is stored only in a predetermined zone in the aforementioned zones, instead of the physical address of the BSI-stored page storing this data, the aforementioned temporary physical address indicating the position of the BSI-stored page in the zone may be stored in the BSI page pointer table.

If the BSI page pointer table stores the temporary physical address instead of the entire digits of the physical address of the BSI-stored page, the amount of data of the BSI page pointer table becomes smaller than the one in the case of storing the entire digits of the physical address. This can reduce the required memory capacity of the RAM 123, so that the memory system can be constructed compact.

The BSI page pointer associated with the BSI-stored page may take such a value as to designate the logical address in which range of the BSI data stored in the BSI-stored page designates is. In this case, in step S701, the CPU 121 may specify that part of the BSI which includes the logical address of a page including the content of a file to be subjected to reading and writing, based on the content of the BSI page pointer table, read only the specified part from the flash memory 11 and temporarily store the read part in the RAM 123. Processes of steps S702 and S703 to be discussed later should be carried out by treating the temporarily-stored part as the BSI. Executing such processes eliminates the need for the operation of reading the entire BSI from the flash memory 11 every time the BSI is referred to, thus shortening the time required to refer to the BSI.

The installed memory unit 1 and the computer 2 may be connected to each other in a fixed manner or the memory unit 1 and the computer 2 may be assembled in the same casing as shown in FIG. 6.

While the embodiment of the invention has been described above, the memory system of the invention is not limited to an application-specific system but may be realized by using an ordinary computer system. For example, a memory system which executes the above-described processes can be constructed by installing a program for executing the above-described processes into a personal computer having a slot to mount the flash memory 11 from a medium (flexible disk, CD-ROM or the like) having the program stored therein.

The program may be uploaded to, for example, a BBS via a communication circuit and distributed via the communication circuit. Alternatively, a carrier wave may be modulated with a signal representing the program, the obtained modulated wave may be transmitted and a device, which receives the modulated wave, may demodulate the modulated wave to restore the program.

Then, the above-described processes can be executed by activating the program and executing the program in the same manner as other application programs under the control of the OS.

In case where the OS performs some of the processes or the OS constitutes a part of a single structural element of the invention, the program excluding that portion may be stored in the recording medium. It is premised in this case too that a program for performing the individual functions or steps that are executed by a computer is stored in the recording medium in the invention.

The invention is based on Japanese Patent Application No. 2002-178674 filed on Jun. 19, 2002, and includes the specification, claims, drawings and abstract of that application. The present specification incorporates what is disclosed in the application entirely by reference.

### INDUSTRIAL APPLICABILITY

The invention can be adapted to a memory device, which is readable and programmable by a computer.

1. A memory device characterized by comprising:
a non-volatile memory (11) including a plurality of memory blocks for storing data to which physical addresses are allocated, each of said blocks including physical pages, each of said physical pages including a logical page and a redundancy portion;
a translation table memory (123) which stores an address translation table (BPT) showing a correlation between physical addresses of pages constituting each of said memory blocks and logical addresses of said pages;
a pointer memory (123) which specifies an empty page in a data storable state from among said pages and stores a write pointer (BSI) indicating a physical address of said specified empty page; and
a controller (12, S311, S314) which, when this memory system is activated, performs initializing process in which reads data from the redundancy portions of said non-volatile memory and prepares the address translation table in said translation table memory and the write pointer in said pointer memory, when to-be-written data and a logical address are supplied to said memory device, writes said to-be-written data in the empty page indicated by said write pointer, and renews said address translation table in such a way as to show a correlation between the physical address of that empty page and said logical address.

2. The memory device according to claim 1, characterized in that said controller (12) designates memory blocks from which data is to be erased from among those memory blocks which have data stored therein (S501), and
discriminates whether data stored in said designated memory blocks is valid or not, for each of those pages which constitute said designated memory blocks, transfers that data which has been discriminated as valid to another memory blocks (S502, S506), and erases that data which is stored in said designated memory blocks (S503).

3. The memory device according to claim 2, characterized in that said controller (12) discriminates whether or not the number of those memory blocks which do not have data stored therein becomes a number which does not satisfy a predetermined condition (S317), and
designates memory blocks from which data is to be erased from among data-storing memory blocks when having discriminated that the number of said memory blocks which do not have data stored therein has become the number which does not satisfy said predetermined condition (S501).

4. The memory device according to claim 3, characterized in that said controller (12) writes an invalid flag indicating that data stored in a page to which a logical address has been allocated at a time to-be-written data and said logical address are supplied to said memory device is invalid in that page once (S310), and
said controller (12) designates an oldest-data storing memory block among those data-storing memory blocks which include pages where said invalid flag is written once, as a memory block from which data is to be erased (S501).

5. The memory device according to claim 4, characterized in that said controller (S502, S506) eliminates data stored in that page where said invalid flag is written once from those targets which are to be transferred to said another memory block.

6. The memory device according to claim 3, characterized in that a physical address includes block addresses indicating that block to which a page indicated by said physical address belongs, and block address are cyclically ordered, and
said controller (S501) designates, as a memory block from which data is to be erased, that one of data-storing memory blocks which is or follows a last block where data has been erased and to which a top block address is given.

7. The memory device according to claim 6, characterized in that said controller (12) writes an invalid flag indicating that data stored in a page to which a logical address has been allocated at a time to-be-written data and said logical address are supplied to said memory device is invalid in that page once (S310), and
eliminates data stored in that page where said invalid flag is written once from those targets which are to be transferred to said another memory block (S502, S506).

8. The memory device according to claim 6, characterized in that said controller (12) writes a logical address supplied to said memory device in that page where said to-be-written data has been written (S314), and
discriminates whether or not said logical address stored in said page coincides with that logical address which is associated with the physical address of that page in said address translation table, and eliminates data stored in that page from those targets which are to be transferred to said another memory block when having discriminated that there is no coincidence (S501, S502, S506).

9. The memory device according to claim 8, characterized in that physical addresses are cyclically ordered, and
said pointer memory (123) specifies a top one of those empty pages which are given physical addresses equal to or following the physical address of that page where data is written.

10. The memory device according to claim 9, characterized in that when the logical address of a to-be-read page is supplied to said memory device, a physical address associated with said logical address is specified based on said address translation table and data is read out from that page which is indicated by said specified physical address and is sent outside (S206 to S214).

11. The memory device according to claim 9, characterized in that when the logical address of a to-be-read page is supplied to said memory device, that page which is given said logical address is specified based on said address translation table and data is read out from said specified page and is sent outside (S206 to S214).

12. The memory device according to claim 11, characterized in that said address translation table shows a correlation between predetermined upper digits of the physical address of each page and the logical address of that page,
said controller (12) writes a logical address supplied to said memory device in that page where said to-be-written data has been written; and
when the logical address of a to-be-read page is supplied to said memory device, a value of said predetermined upper digits of the physical address associated with said logical address is specified based on said address translation table and data is read out from that page which is included in individual pages each having a physical address whose upper digits coincide with said specified value and in which said logical address of said to-be-read page is written, and is sent outside (S206 to S214).

13. The memory device according to claim 12, characterized in that said controller (12) writes an invalid flag indicating that data stored in a page to which a logical address has been allocated at a time to-be-written data and said logical address are supplied to said memory device is invalid in that page once (S310), and
data is read out from that page which is included in individual pages each having a physical address whose upper digits coincide with said specified value and in which said logical address of said to-be-read page is written and said invalid flag is not written, and is sent outside (S206 to S214).

14. The memory device according to claim 8, characterized in that physical addresses are cyclically ordered,
said pointer memory (123) specifies a top one of those empty pages which are given physical addresses equal to or following the physical address of that page where data is written, and
said controller (12) reads out data from a lowest-ordered page in those individual pages each having a physical address whose upper digits coincide with said specified value and in which said logical address of said to-be-read page is written, and sends said data outside (S206 to S214).

15. The memory device according to claim 11, characterized in that said address translation table shows a correlation between predetermined lower digits of the physical address of each page and the logical address of that page, and a range over which a value of a physical address can be associated with a logical address is determined for each logical address, and
when the logical address of a to-be-read page is supplied to said memory device, said controller (S206 to S214) specifies a value of said predetermined lower digits of the physical address associated with said logical address is specified based on said address translation table, and reads out data from that page which is included in individual pages each having a physical address whose lower digits coincide with said specified value and which is given a physical address lying in said range, and sends that data outside.

16. The memory device according to claim 15, characterized in that said translation table memory (123) is constituted by a non-volatile memory which stores said address translation table.

17. The memory device according to claim 15, characterized in that said translation table memory (123) is constituted by the page that stores said address translation table, and
said controller (S310 to S312) reads at least a part of said address translation table from said page, renews said read part in such a way as to show a correlation between the physical address of said empty page indicated by said write pointer and said logical address and writes said renewed part in another empty page (S601 to S603).

18. The memory device according to claim 17, characterized in that said controller (12) stores an address translation table storage location list showing physical addresses of those pages which store data constituting said address translation table (S105B),
reads at least a part of said address translation table from that page which is given a physical address indicated by said address translation table storage location list, renews said read part in such a way as to show a correlation between the physical address of said empty page indicated by said write pointer and said logical address and writes said renewed part in another empty page, and
renews said address translation table storage location list in such a way as to show the physical address of said another empty page (S602, S603).

19. The memory device according to claim 17, characterized in that a range of a value of upper digits of the physical address of each of those pages which store data constituting said address translation table is predetermined,
said controller (12) stores an address translation table storage location list showing predetermined lower digits of the physical address of each of those pages which store data constituting said address translation table (S105B),
reads at least a part of said address translation table from that page which is included in pages each having a physical address whose predetermined lower digits are specified by said address translation table storage location list and the predetermined upper digits of the physical address of which lies in said range, renews said read part in such a way as to show a correlation between the physical address of said empty page indicated by said write pointer and said logical address and writes said renewed part in another empty page, and
renews said address translation table storage location list in such a way as to show the physical address of said another empty page (S602, S603).

20. The memory device according to claim 19, characterized in that said controller (S601 to S603) specifies that page which stores a part showing a correlation between said logical address supplied to said memory device and said physical address from among those pages which have said address translation table stored therein, reads only that part which is stored in said specified page, renews said read part in such a way as to show a correlation between the physical address of said empty page indicated by said write pointer and said logical address and writes said renewed part in another empty page.

21. The memory device according to claim 20, characterized by further comprising a non-volatile memory (123) which stores an empty block table containing information for identifying that memory block which does not have data stored therein, and
in that said controller (12), further, discriminates whether or not writing to-be-written data supplied to said memory device in an empty page has resulted in that the memory block which includes said empty page has no further empty page, and renews said empty block table in such a way as to indicate that said memory block including said empty block has said data stored therein, when having discriminated that said memory block including said empty block has no further empty page (S315, S316), and
renews said empty block table in such a way as to indicate that a memory block from which data to be stored has been erased does not have that data stored therein.

22. The memory device according to claim 20, characterized in that some of said pages constitute empty block table memory means (11) which stores an empty block table containing information for identifying that memory block which does not have data stored therein, and
said controller (12), further, discriminates whether or not writing to-be-written data supplied to said memory device in an empty page has resulted in that the memory block which includes said empty page has no further empty page, and, when having discriminated that there is no further empty page, reads at least a part of said empty block table from said empty block table means, renews said empty block table in such a way as to indicate that said memory block including said empty block has said data stored therein, and stores said renewed empty block table in said empty block table means (S315, S316), and
reads at least a part of said empty block table from said empty block table means, renews said empty block table in such a way as to indicate that a memory block from which data to be stored has been erased does not have said data stored therein, and stores said renewed empty block table in said empty block table means (S504).

23. The memory device according to claim 22, characterized in that said controller (12) stores an empty block table pointer indicating the physical address of a page storing that data which constitutes said empty block table (S107), and reads at least a part of said empty block table from that page which is given said physical address indicated by said empty block table pointer.

24. The memory device according to claim 22, characterized in that a range of a value of upper digits of the physical address of each of those pages which store data constituting said address translation table is predetermined, and
said controller (12) stores an empty block table pointer indicating predetermined lower digits of the physical address of a page storing that data which constitutes said empty block table (S 107), and reads at least a part of said empty block table from that page which is included in pages each having a physical address whose lower digits are specified by said empty block table pointer and which has a physical address whose upper digits lie in said range (S308).

25. The memory device according to claim 24, characterized in that said controller (12) specifies that page in which a to-be-renewed part in said stored empty block table is stored from among those pages which have said empty block table stored therein, and reads out only that part which is stored in said specified page.

26. A memory managing method for managing a non-volatile memory having a plurality of memory blocks for storing data to which physical addresses are allocated, and each of said memory blocks including physical pages, each of said physical pages including a logical page and a redundancy portion, characterized in that
said method comprises the steps of:
when said non-volatile memory is activated, reading data from the redundancy portions of said non-volatile memory and preparing an address translation table showing a correlation between physical addresses of pages constituting each of said memory blocks and logical addresses of said pages and a write pointer indicating a physical address of an empty page,
receiving to-be-written data and logical address; and
when to-be-written data and a logical address are supplied, writing said to-be-written data in the empty page indicated by said write pointer, and said address translation table is renewed in such a way as to show a correlation between the physical address of that empty page and said logical address (S311, S314).

27. The memory managing method according to claim 26, characterized in that memory blocks from which data is to be erased is designated from among those memory blocks which have data stored therein (S501), and,
discriminating whether data stored in said designated memory blocks is valid or not, for each of those pages which constitute said designated memory blocks, transferring that data which has been discriminated as valid to another memory blocks, and erasing that data which is stored in said designated memory blocks (S502, S506, S503).

28. The memory managing method according to claim 27, characterized in that discriminating whether or not the number of those memory blocks which do not have data stored therein becomes a number which does not satisfy a predetermined condition (S317), and
when it is discriminated that the number of said memory blocks which do not have data stored therein has become the number which does not satisfy said predetermined condition, designating a memory block from which data is to be erased from among data-storing memory blocks (S501).

29. A program for allowing a computer (121), connected to a memory (11) including a plurality of memory blocks for storing data to which physical addresses are allocated, to function to:
store an address translation table showing a correlation between physical addresses of pages constituting each of said memory blocks and logical addresses of said pages (S105);
specify an empty page in a data storable state from among said pages and store a write pointer indicating a physical address of said specified empty page (S107); and
when to-be-written data and a logical address are supplied to said computer, write said to-be-written data in the empty page indicated by said write pointer and renew said address translation table in such a way as to show a correlation between the physical address of that empty page and said logical address (S311, S314).

30. The program according to claim 29, characterized in that said program designates memory blocks from which data is to be erased from among those memory blocks which have data stored therein (S501), and
discriminates whether data stored in said designated memory blocks is valid or not, for each of those pages which constitute said designated memory blocks, transfers that data which has been discriminated as valid to another memory blocks, and erases that data which is stored in said designated memory blocks (S502, S506, S503).

31. The program according to claim 30, characterized in that said program discriminates whether or not the number of those memory blocks which do not have data stored therein becomes a number which does not satisfy a predetermined condition (S317), and
designates memory blocks from which data is to be erased from among data-storing memory blocks when having discriminated that the number of said memory blocks which do not have data stored therein has become the number which does not satisfy said predetermined condition (S501).
